(19) United States
(12) Patent Application Publication
(10) Pub. No.: US 2013/0344932 A1
(43) Pub. Date: Dec. 26, 2013

(54) METHOD AND APPARATUS FOR EXECUTING A LOTTERIZED VIDEO GAME

(71) Applicants: Cameron Adams, Kamloops (CA); Jason Lam, Kamloops (CA)

(72) Inventors: Cameron Adams, Kamloops (CA); Jason Lam, Kamloops (CA)

(73) Assignee: BRITISH COLUMBIA LOTTERY CORP., Kamloops, BC (CA)

(21) Appl. No.: 13/978,517

(22) PCT Filed: Jan. 6, 2012
(86) PCT No.: PCT/CA12/00019

§ 371 Date: Sep. 12, 2013

Related U.S. Application Data
(60) Provisional application No. 61/430,889, filed on Jan. 7, 2011.

(51) Int. Cl. G07F 17/32

(52) U.S. Cl. CPC G07F 17/329
USPC 463/17

(57) ABSTRACT

A system for executing a lotterized video game comprises at least one computer server communicable with at least one client computing device over a network. The server has a processor and a memory with program modules stored thereon and executable by the server. The program modules comprise a game engine module having program code that when executed, generates an interactive game play instance playable on the client computing device; and a lottery services module having program code that when executed, conducts a real lottery transaction within the game play instance.

### TECHNICAL FIELD

The present application relates to a method and apparatus for executing a lotterized video game over a network.

### BACKGROUND

Consumers are increasingly demanding greater access to government sanctioned gambling. Such gambling can take many forms. Conventionally, consumers have participated in draw-type lottery games that require the purchase of a physical lottery ticket prior to a draw. On the physical lottery ticket are printed numbers, letters, symbols, or a hybrid that the consumer hopes will be selected during the draw. After the draw, the consumer can compare the numbers on the ticket to the numbers selected during the draw, and if sufficient numbers match, the consumer is identified as a winner of the draw.

Relatively recently, more elaborate forms of gambling have begun to become mainstream. For example, Internet-based gambling allows consumers to purchase electronic lottery tickets using a government sanctioned gambling website, and to determine via the gambling website whether or not a ticket is a winning ticket. Internet-based gambling allows consumers to purchase electronic lottery tickets and to participate in lotteries from the comfort of their own home or via their mobile device, as opposed to having to attend at a lottery retailer in person to participate.

Notwithstanding the advances in Internet-based gambling, the steps of purchasing electronic lottery tickets from a gambling website are still generally the same as purchasing a traditional physical lottery ticket. As such, purchasing electronic lottery tickets may still be not be sufficiently captivating and interesting to some consumers. Some consumers in particular are increasingly difficult to attract with traditional forms of lottery play. Authorized lottery authorities therefore are increasingly challenged to find ways to keep consumers interested in purchasing lottery tickets.

### SUMMARY

According to one aspect of the invention, there is provided a system for executing a lotterized video game comprising at least one computer server communicable with at least one client computing device over a network. The server has a processor and a memory with program modules stored thereon and executable by the processor. The program modules comprise a game engine module having program code that when executed, generates an interactive game play instance playable on the client computing device; and a lottery services module having program code that when executed, conducts a real lottery transaction within the game play instance.

The game engine module can further comprise program code that when executed, generates an interactive game play instance which provides a player with play options including purchasing a virtual good, and requesting a real lottery transaction associated with the virtual good which when selected executes the lottery services module program code to conduct the real lottery transaction. More particularly, the game engine module can further comprise program code that when executed, presents to the player an opportunity to purchase a real lottery ticket to win a real version of the virtual good, and wherein the lottery services module can further comprise program code that when executed issues one or more unique identifiers associated with the real lottery ticket, and compares the issued unique identifiers with winning identifiers in a real lottery draw for the real version of the virtual good.

The lottery services module can further comprise program code that when executed, issues a unique identifier associated with a real lottery ticket, and compares the issued unique identifier with a winning identifier in a real lottery draw. The program modules can further comprise a player account management module having program code that when executed, determines whether a player of the game play instance is eligible to conduct the real lottery transaction, by receiving player information from the client computing device comprising at least one of player age, residence and location, and comparing the received player information to player eligibility information stored on the server.

The program modules can further comprise a database module having a database storing player account information including the player information, the issued unique identifier associated with a real lottery ticket, and an inventory of purchased virtual goods.

The game engine module can further comprise program code that when executed, provides a player with game play purchase options including purchasing a real lottery ticket which when selected executes the lottery services module program code to conduct the real lottery transaction. The lottery services module can further comprise program code that when executed, issues a unique identifier for at least one real lottery ticket in response to the purchase of the real lottery ticket, and the game engine module can further comprise program code that when executed, presents a task element during the game play instance and displays the at least one real lottery ticket on the client computing device when the task element is successfully completed by the player.

The lottery engine module can further comprise program code that when executed, generates a virtual lottery ticket by receiving a virtual lottery ticket transaction request from the client computing device during the game play instance, processing the transaction request, and randomly generating a virtual prize in response to the virtual lottery ticket transaction request.

According to another aspect of the invention, there is provided a method for executing program code for a lotterized video game on at least one computer server communicable with at least one client computing device over a network. The method comprises executing program code of a game engine module which generates an interactive game play instance playable on the client computing device; and executing program code of a lottery services module which conducts a real lottery transaction within the game play instance.

According to yet another aspect of the invention, there is provided a computer readable medium having encoded thereon: program code of a game engine module executable by a processor to generate an interactive game play instance playable on a client computing device; and, program code of a lottery services module executable by a processor to conduct a real lottery transaction within the game play instance.

### BRIEF DESCRIPTION OF THE DRAWINGS

In the accompanying drawings, which illustrate one or more exemplary embodiments:

FIG. 1 is a system diagram of client computing devices and a computer system which implement a lotterized video game according to one embodiment.

FIG. 2 is a functional block diagram of functional modules that make up the computer system shown in FIG. 1.

FIG. 3 is a flowchart illustrating the generalized game play of the lotterized video game.

FIG. 4 is a flowchart illustrating a lottery subroutine of the generalized game play of the lotterized video game shown in FIG. 3.

FIG. 5 is a flowchart illustrating an action subroutine of the generalized game play of the lotterized video game shown in FIG. 3.

FIG. 6-9 are screenshots of the game play displayed on a client computing device.

### DETAILED DESCRIPTION

The embodiments described herein relate to a lotterized video game that is executed by a computer system and is playable over a network on one or more remote client computing devices. Unlike conventional video games which simulate lottery play or other gambling games, the lotterized video game of the present embodiments can conduct a lottery transaction within an interactive game play instance which issues a real lottery ticket from a government sanctioned lottery authority (“real lottery transaction”). As the lottery ticket is issued within the game play instance, a user's game playing experience is enhanced with the prospect of knowing that a prize of real value can be won. Additionally, the lottery experience is enhanced by incorporating fun game play elements into the lottery purchasing experience. Such fun game play is expected to attract those consumers who would not be as attracted to traditional forms of lottery play, such as purchasing physical lottery tickets or electronic lottery tickets via a lottery issuer's website.

In the embodiments described herein, the game concept simulates the experience of a new winner of a lottery, and allows players to live out their fantasy of winning the lottery by allowing the players to spend virtual dollars from a virtual winning lottery ticket. A player can over the course of the game build up and enjoy a virtual lifestyle of a lottery winner by purchasing and enjoying virtual luxury goods; the player can also uncover real lottery tickets that are included in the player's initial purchase of a game play, as well as further purchasing real lottery tickets during the course of game play.

The lotterized video game can be monetized by: selling a one time or subscription based purchase of one or more game play instances, selling subscriptions that include multiple virtual lottery tickets; selling real lottery tickets directly during game play; and/or selling virtual currencies and goods used in the game play.

The lotterized video game is lotterized by allowing player to “unlock” real lottery tickets hidden during a game play instance, or to allow the player to purchase real lottery tickets during a game play instance. These real lottery tickets can award the player with real prizes having real monetary value, or virtual cash (which could have real monetary value) that the user can use to continue game play.

The lotterized gaming system is managed by a gaming operator, who can be the governmental lottery authority, or who can be an agent which is contracted to administer the lottery gaming system. Game players can be existing subscribers of lottery services from the governmental lottery authority, or one-time players. In jurisdictions which legislatively regulate gambling, the players must meet the legislative gambling requirements in the jurisdiction where the lotterized video game is played; such requirements typically include residency and presence within the jurisdiction while the game is played, and a minimum age.

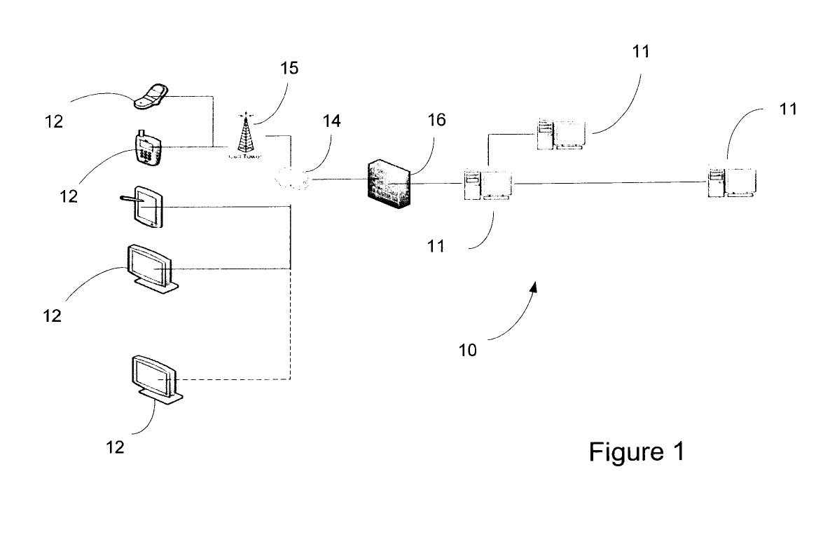

Referring now to FIG. 1, there is depicted the main components which execute the lotterized video game. The components include a server system 10 comprising one or more interconnected computer servers 11 (three of which are shown in this Figure merely for illustration), and multiple client computing devices 12 connected to the servers 10 via a wireless network 14 and through a firewall 16 located between the network 14 and the servers 11. The client computing devices 12 can be cellular smartphones which connect to the servers 11 via a cellular network 15, or computers such as tablets, laptops or desktop computers which connect to the servers via the World Wide Web. The client devices have input and output mechanisms such as touch-sensitive display screens and/or buttons which allow players to interact with the lotterized video game during a game play instance.

### Server System Architecture

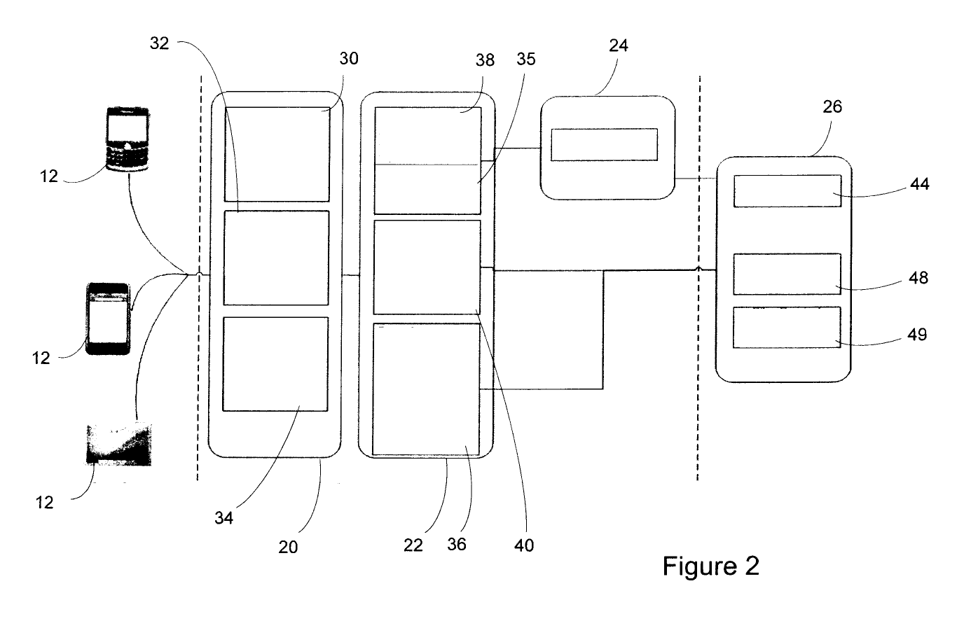

Referring now to FIG. 2, the server system 10 in this embodiment comprises four interconnected servers; however, a different number of servers can be used in a manner as known in the art. In this embodiment, the server system 10 comprises a web server 20, an application server 22, a database server 24, and a lottery server 26. The server system 10 can comprise, for example, multiple Apache Servers that are clustered and load balanced and which will dispatch requests to other services on other servers via an enterprise service bus (ESB). Each server includes a memory and a processor for storing and executing instructions to implement aspects of the lotterized video game. The instructions can also be stored on a computer readable medium, which includes any form of semiconductor-based memory or disc-based media such as compact discs, digital video discs, hard disks, flash memory, random access memory, and read only memory. The hardware architecture of computer servers and supporting hardware is well known in the art and thus not discussed here in further detail.

Each server 20, 22, 24, 26 has stored in its memory one or more program modules which are executed by the server's processor to implement certain functions of the lotterized video game. More particularly, the web server 20 includes a web services module 30 which publishes application and gaming services (API), a platform controller module 32 which manages traffic between the client computing devices and server system 10, and in particular routes calls to the correct program modules, and a mobile smart engine module 34 which handles mobile specific tasks such as mobile provisioning (e.g. deploying to specific client computing devices such a Blackberry® or iPhone® mobile smartphone).

The application server 22 includes a game engine module 35 which manages the primary game play mechanics, a dynamic multiplayer engine module 36 which manages multiple instances and simultaneous multiplayer game engines and connections, a social engine module 38 which execute various social networking functions of the lotterized video game, and a proxy engine module 40 which handles players' account, wallet, wagers and transactions between the client computing device 12 and one or more program modules which handle these services. The database server 24 includes a MySQL database module 42 which stores social networking data used by the social engine module 38.

The lottery server 26 includes a player account management (PAM) module 44 which manages aspects of the players' account with the gaming operator and the lottery authority (if different from the gaming operator), a lottery services module 48 which executes lottery transactions such as validating a lottery ticket request, conducting a ticket purchase, generating a lottery ticket, generating a winning number, and comparing generated lottery tickets to the winning number to determine winning tickets. The lottery server 26 can also include other modules 49 to support the execution of lottery services, such as generating financial reports. The lottery server 26 can be a dedicated server that only issues real lottery tickets and administers real and virtual lottery draws for the lotterized video game, or can issue lottery tickets and administer lottery draws for different lottery game that are offered by the governmental lottery authority. For example, the lottery authority can offer other types of lottery games for play on an on-line gaming website.

When the gaming operator is the same as the lottery authority, functions of the lottery server 26 can be optionally integrated with functions carried out by the other servers 20, 22, 24 of the system 10. However, when the gaming operator is a separate entity from the lottery authority, lottery related transactions will typically be handled by a separate lottery server administered and secured by the governmental lottery authority, which communicates over the necessary secured channels with the other servers of the system 10.

### Client Architecture

The lotterized video game client is a cross-platform application playable on different types of client computing devices 12. The client application does not carry out any transactions; all transactions including lottery and payment transactions are performed by the server system 10.

The client application can be implemented on different platform architectures, namely: (a) entirely web-based solution, (b) web-based solution with localhost permissions, (c) web-based solution with a native application, (d) entirely native application and (e) web-based platform/semi-distributed system.

(a) Entire Web-Based Solution:

In this approach, the entire client application is presented through a web browser. The client application is implemented with the JEE technology stack, Web 2.0 technology and Flash/Flex where required. Flash/Flex is mainly utilized when animation is required (the animation in this embodiment are pre-scripted and are for entertainment value; no animation is required for game play interaction). To implement the client application, the web browser is set to full view mode and all features other than the main view port is disabled. The player is prevented from exiting the browser and from accessing the operating system and any application outside the game client application.

As the client application is a web application, it can be implemented with a variety of technologies such as but not inclusive to Silverlight, Flash, HTML/Javascript and Java Applet. Such a web application is relatively easy to deploy, maintain and update as all the gaming logic resides on the server system 10. Also advantageously, the client application is hardware and operating system agnostic, and requires only a suitable web browser.

(b) Web Based Solution with Local Host Permissions

In addition to what is provided in a web based solution, additional local host information can be obtained through known technologies that have rights to access the client computing device. One possible solution is to use a signed Java Applet.

(c) Web Based Solution with a Native Application

In addition to what is provided in a web based solution, a non web-based executable program can be installed on the client computing device 12 when the client computing device 12 is powered on. This executable program can be launched simultaneously with the client application itself. The executable program gathers the required hardware information and sends the information to the web server via HTTP. One of the required initialization steps for the client application itself includes waiting for the hardware information to have been successfully sent to and validated by the server system 10. With the ability to access hardware information, the client application can potentially add additional security checks, and have access to hardware for enhanced user interaction, e.g. accelerometer.

(d) Native Application.

The client application can be a native application implemented on one of the various operating systems available to the client computing devices, such as Android, Microsoft, Apple OSX, or Flash.

(e) Web-Based Platform/Semi-Distributed System.

In this approach, an embedded web server is installed on the client computing device itself. The web server would locally serve web pages. However, the main responsibility of the local web server is to only provide a mechanism to display the “view” of the game. All gaming logic and persistence is through calls back to the web service module of the server system 10. An advantage for this approach is providing a distributed network which could potentially offset work load to the server system 10.

### Program Modules

Each of the program modules 30 to 49 is implemented as program code that is executed on one of the servers of the server system 10. The following is an explanation of the functions of some of these modules.

Web Services Module.

The web services module 30 contains a number of web services, i.e. application programming interfaces (API) that are accessed via hypertext transfer protocol (HTTP) and executed on the client computing devices 12. The purpose of the web service module 30 is to support interoperable client computing device-to-server system interaction over the network. In the web services module 30, each significant web service is modeled after a Page Controller pattern as is known in the art. However, within each significant web service, simplistic controller statements (basic factory using IF/OR switch statements) are used to direct request calls appropriately. The transport protocol is available in two forms, namely either XML or JSON, where XML is the default transport message protocol.

Examples of notable web services carried out by the web services module 30 are:
“Friends”: A service that allows a player to build his or her social graph, i.e. a player's relationship with other members in the system. These relationships are part of the “social” aspect of any social lottery game. The basic functionality features allow a player to “add”, “remove” and “manage” friends in the player's network (“friends list”). These relationships in turn allows the player to easily track and compare other players' social status including but not exclusive to LeaderBoards, challenge results, achievements, lottery awards and rankings.
“PlayerAccount”: This represents the player's basic account settings such as real name, address, contact information (phone numbers, address), financial account information such method of payment and payment/billing information (hereinafter referred to as “wallet information”) and player profile information (avatar, player dislikes and likes, player preferences such game types)
“LeaderBoard”: This represents a method of tracking player progression at the server level based on any assigned attribute and/or player statistics including but not exclusive to the player experience, lottery winning status, scores, percent lottery wins, custom attributes. The objective of LeaderBoards is to create a friendly competition between global players and/or competition between friends within the same network/group
“Group(s)”: Otherwise more commonly known in video games as clans and/or guilds. Represents small groups of players organized by the players themselves. These groups build ‘stronger’ relationships between players from a social aspect and ‘gaming’ aspect'. In terms of ‘gaming aspect’ there may be opportunities where a group can challenge other groups, participate in group lottery draws and/or pool resources to achieve a greater social standing. Groups are another feature to the game that encourages “social behaviour”, promote lottery participation and increases the longevity of players returning to play the game.
“Achievements”: This represents a variety of ‘goals/objectives’ a player has accomplished in a game. It is an added incentive for a player's longevity in returning to the game. Achievements can be directly awarded to players based on lottery outcomes; for example, a player who wins the most in a particular game and reaches the top spot on a LeaderBoard could receive a ‘top title’ achievement. Achievements themselves can encourage players to increase lottery play; for example, an achievement title could be awarded to a player who has played each type of lottery game at least once. Achievements are not necessarily awarded for positive outcomes; for example, if a player currently is last place compared to his/her friends in the player's group for over a month could be awarded a special achievement title.
“Gifting”: This represents a player's method of awarding other players monetary and non-monetary items. As a specific example, a possible direct monetary gift is a real lottery ticket and an indirect lottery gift a virtual invitation to a virtual trip to a destination, wherein all players who accept the invitation are entered into a real lottery to win a real trip to the destination.
“Rank”: This represents a player's overall status/standing of entire game network or specific to a game. Ranks are based on the player's overall standing method of score/player experience points. Player experience points is tracked based on the player progression in every lottery task/game the player participates in.

Player Account Management Module.

As noted above, the proxy engine module 40 makes proxy calls between the client device and function modules to carry out certain functions. One such function module is the PAM module 44 which is located on the lottery server 26. The PAM module 44 executes player account functions, such as:
CreatePlayer: create a player account in the database module 42
ValidatePlayer: validate an existing player's login and password, or new player's eligibility to play the game;
SuspendPlayer: suspend a player's account; this does not remove a player's account from the system but rather it disallows the player to login and participate in a game instance.
ActivatePlayer: a player has successfully registered and is permitted to participate in a lottery game instance;
CreateProfile: create a player profile
ViewProfile: view player information stored in the player account
ViewWallet: view current balance of player's real money account in the player account
UpdateWallet: update current balance of player's real money account
UpdateOnlineStatus: update a player's virtual ranking/status

Game Engine Module.

The game engine module 35 contains gaming logic program code executable by a processor to carry out an interactive gaming session (i.e. a game play instance) playable on the client device. The programming architecture of the game engine module 35 is a Transaction Script pattern, which organizes the video gaming logic primarily as a single procedure, making calls directly to the database module 42. Of note, the social engine module 38 is generic in nature and does not contain specific gaming logic; the video gaming logic is handled by the game engine module 35.

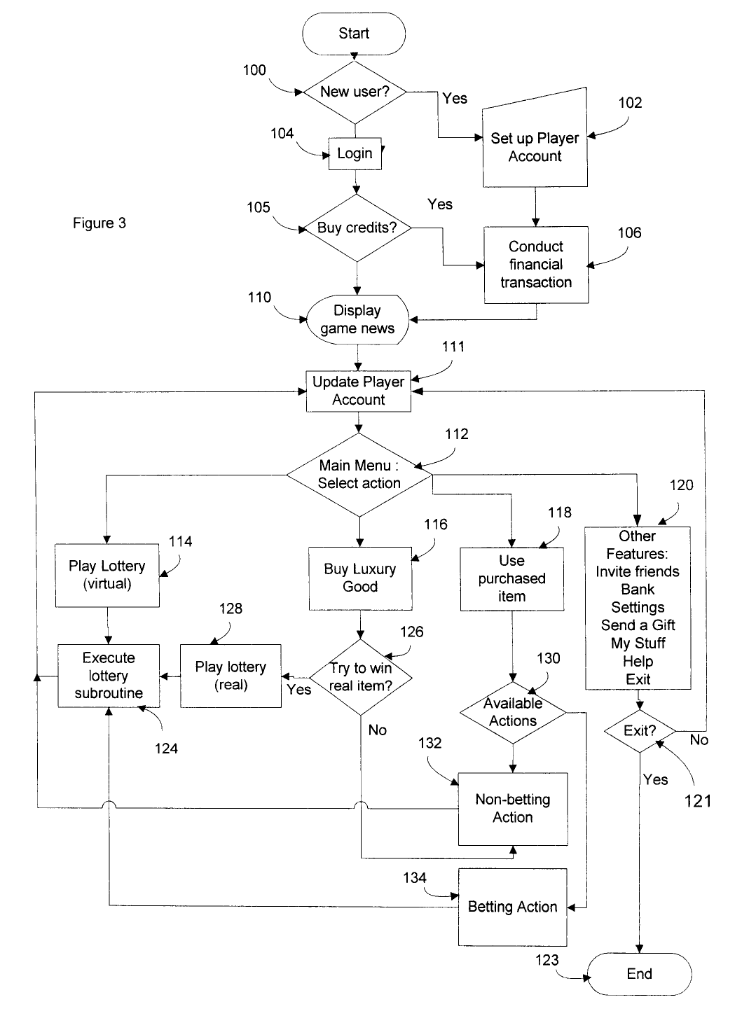

Referring to FIGS. 3 to 9 the video gaming logic and the interaction between the game engine module 35 and the other function modules of the system 10 to carry out a game play instance of the lotterized video game will now be described.

Referring to FIG. 3, a game play instance is started when the player starts the client application on his client computing device 12. The client application asks whether the player is a new player or an existing player (step 100). If the player selects new player, the client application executes a Set Up Player Account function (step 102) wherein the client application asks the player to register with the gaming operator, and in particular, asks the player to provide player information, including name, birth date, address, and to choose a user ID and password. The client application also asks the player to select manner of payment and to provide financial transaction information according to the selected manner of payment, for example, credit card information. The client application then sends the inputted player information and financial transaction information along with a CreatePlayer request to the server system 10 which causes the PAM module 44 to execute the CreatePlayer function.

When executed, the CreatePlayer function adds a new player profile account in a database stored in the database module 42, and populates the account with the following fields in the database: “player address”, “player birth date”, “credit card information”, “real monetary balance” (otherwise known as the player's “Wallet”), and “virtual credit balance”. Credit card information may be validated by a third party operator in communication with the server system 10. The PAM module 44 then executes the ValidatePlayer function to verify the player's age and residency using the supplied birthdate and address. If equipped with a GPS radio, the client computing device 12 can also transmit GPS coordinates to the server system 10 which is then used by the ValidatePlayer function to verify the player's location; if such GPS coordinates are not available, the server system 10 will determine location by other means, for example, by determining location for the client computing device's IP address, or by asking the player for his current location. Many mobile devices contain GPS transmitters/receivers and obtaining GPS coordinates and verifying device location is well known in the art and not further elaborated here.

The PAM module then executes the CreateProfile function which creates a player profile in the player account in the database, and populates the player's account with the following fields in the database: “credits balance”, “virtual currency balance”, “invites available”, “real lottery ticket information”, “virtual lottery ticket information”, “virtual goods inventory”, “current lottery standing”, and “social standing”. Credits are analogous to casino chips and can be purchased or won during game play and can be used to buy virtual currency in the game, which are referred to as “MegaBucks” in this embodiment. MegaBucks can be used during game play to buy virtual goods or purchase virtual lottery tickets. Invitations are a social networking device which allows a player to invite a friend to participate in the game play, and can be purchased or won during game play. Real lottery information relates to real lottery tickets that are issued by the governmental lottery authority via the lottery server 26 to win real prizes of real monetary value; the tickets are issued and played in a real lottery transaction conducted during a gaming instance. A certain number of real lottery tickets can be purchased a la carte, included with a bundle purchase or credits, invites and real lottery tickets, or be issued periodically in a subscription purchase. In one embodiment, the real lottery tickets are hidden from the player during a gaming instance inside of “presents”. The game play is designed to unveil the tickets when the player successfully completes a task in the game and is awarded a present; however, the game play could be designed to eventually unveil all of the purchased real lottery tickets regardless of how well the player plays the game or present the tickets at the player's prompt. Virtual lottery ticket information relates to virtual lottery tickets that can be purchased or won during game play and which may award credits, invites or virtual prizes. Virtual goods inventory stores information about the virtual goods purchased by the player during game play. Current lottery standing is a log of the player's real and/or virtual lottery winnings. Social standing is a comparison of certain player attributes and achievements relative to other players of the lotterized video game.

Once the player's financial transaction information is accepted and eligibility is validated, the PAM module 44 executes the ActivatePlayer function and causes the server system 10 to transmit a “Player Registered” response back to the client computing device 12 which then generates a suitable message to the player. The client application then prompts the player to make a one-time purchase of a game bundle, or subscribe to subscription play (step 106): The client computing device 12 then sends a purchase request to the server system 10 and the PAM module 44 checks the Wallet of the player's account on the database module 42 to determine whether sufficient funds exist to process the request; if yes, the PAM module 44 updates the player's account. When a player purchases a game bundle, his account is updated by updating his Wallet to deduct the real money payment of the game bundle, to add the purchased virtual credits, and to add the purchased invites and number of real lottery tickets. The PAM module 44 then transmits a “Transaction Approved” response to the client computing device 12 which then generates a suitable message to the player.

A game bundle includes a certain number of credits, invites, and real lottery tickets for a certain price which can be modified by the lottery operator from time to time. For example, the following game bundles can be offered:

| Price | Credits | Invites | Real Lottery Tickets |
|---|---|---|---|
| $3 | 25 | 3 | 3 |
| $5 | 50 | 5 | 6 |
| $10 | 120 | 10 | 15 |
| $20 | 300 | 20 | 40 |

Subscription play will periodically (e.g. once a month) issue credits, invites and real lottery tickets and charge the player's credit card or debit card. Alternatively, players may be able to deposit cash into their account at any of the lottery operator's physical locations or authorized agents.

If instead the player is an existing player, then the client application requests the player to login by providing his user ID and password (step 104). This information is transmitted by the client computing device 12 to the server system 10 for execution of a “Login” transaction wherein the PAM module 44 executes the ValidatePlayer function to compare the user ID and password against information in the player's account on the database module 42. If a match is found, the ViewProfile and ViewWallet functions are executed wherein the player's profile is retrieved from the player's account, and the ActivatePlayer function is executed which communicates to the client application a message that login was successful and the player's profile information. The player's profile includes the player's current lottery standing, social standing, and virtual and real currency (Wallet) balances. This information is transmitted by the server system 10 back to the client computing device 12 along with a “Login Successful” response to the client computing device 12 which then generates a suitable message to the player.

Once the login information has been accepted, the client application asks whether the player wishes to buy Credits (step 105). If yes, the client computing device transmits a “Purchase Credits” transaction request to the server system 10 and the PAM module 44 checks the player's account to determine whether sufficient funds exist to purchase Credits; if yes, the PAM module 44 updates the player's account accordingly (step 111), and transmits a “Transaction Approved” response to the client computing device 12 which then generates a suitable message to the player. The client application then asks whether the player wants to make a one time purchase of a game bundle, or subscribe to subscription play (step 106) for a single game play instance, in the manner as described above.

After the player has registered as a new player or logged in as an existing player, the client application then causes the client computing device 12 to transmit a “Play Game” request to the system server 10 (if registering as a new player, the request will be for a new game instance; if a returning player, the player is presented with the option of starting a new game instance, or continuing with a saved game instance). In response, the gaming engine module 35 executes a gaming news subroutine, wherein information of interest to the player is collected and sent from the system server 10 to the player's device 12 for display as gaming news by the client application (step 110). Such information can include the current value of the progressive real money jackpot, or recent activity of one of the player's friends. The value of the real money jackpot is recorded in the database module 42. Friends' activities can be monitored using the social engine, as will be described in detail below.

It is noted every transaction by every player is logged in the database module 42; the sum of all real lottery ticket purchases are subtracted from all jackpot winnings and this value is recorded in the database module 42 as the current progressive real money jackpot.

Depending on the limit decided by the lottery authority, each jackpot winnings is automatically credited to a player's account. Any jackpot winning that exceeds this limit is temporarily locked away for manual review, audit, approval and manual release by lottery authority personnel to the player.

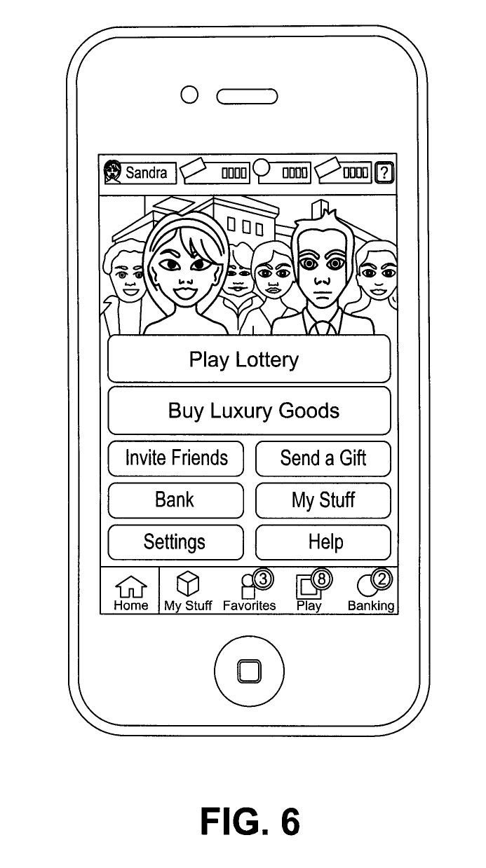

After the player is finished viewing the gaming news, the player can select to continue to the main menu. The player's account is then updated with any new transactions or changes in player information (step 111) and then the gaming engine module 35 proceeds to the main menu step (step 112). At the main menu (see FIG. 6), the client application displays a main menu screen, which presents the player with multiple play options, namely: “Play Lottery” (step 114), “Buy Luxury Goods” (step 116), and a number of secondary features (step 120): “Invite Friends”, “Send a Gift”, “Bank”, “My Stuff”, “Settings” and “Help”, and “Exit”. If the player's account includes goods that the player has previously purchased, then the main menu also displays a “Use Purchased Item” (step 118 in FIG. 3, not shown in FIG. 6) option. The main menu also includes a ribbon 122 which displays certain information from the player's profile, including the player's name, virtual currency balance, credit balance, and other stores of value that the game may use such as “gold”.

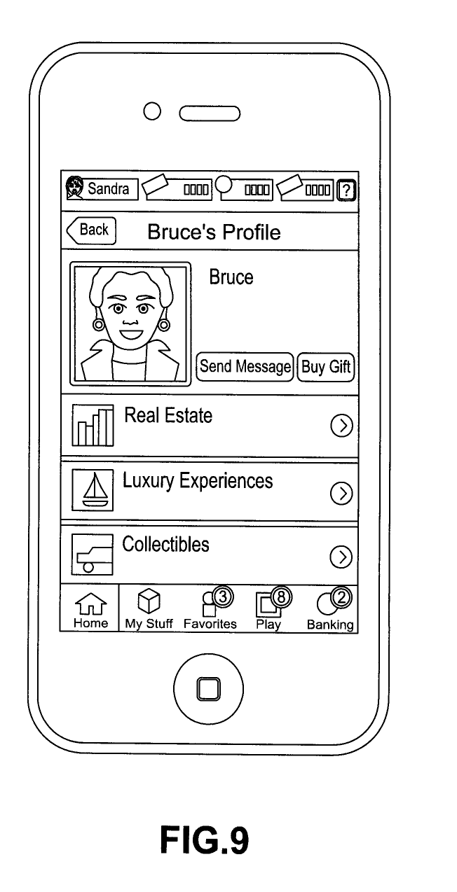

When the player selects “My Stuff”, the PAM module 44 initiates a function which causes the client application to display her items (see FIG. 9).

When the player selects “bank” the game engine returns to the “conduct financial transaction” step (106) to allow the player to buy real lottery tickets with Credits or real funds.

When the player selects “Exit” (step 121) the player account is updated, the game instance state is saved, and the client application is terminated (step 123).

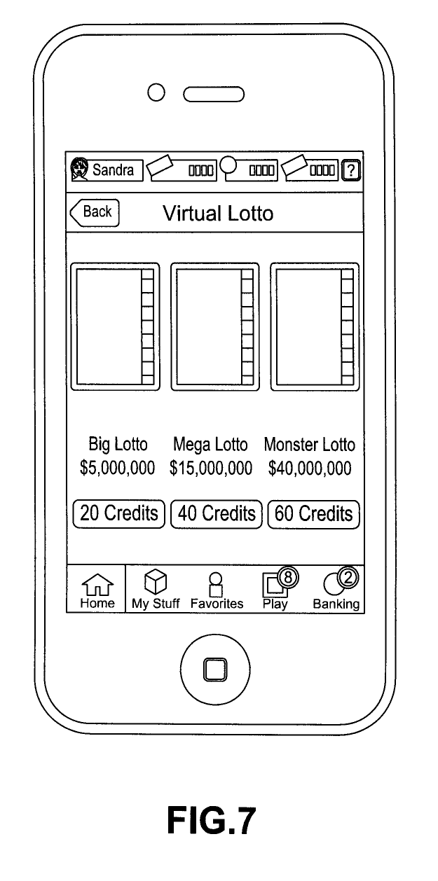

When the player selects the “Play Lottery” button on the main menu, the client computing device sends a “Play Virtual Lottery” request to the server system 10; the client application then executes a “Play Virtual Lottery” subroutine which causes the client application to display a “VirtuaLotto” screen wherein the player is presented with choices to buy virtual lottery tickets of different prices (in Credits), and which have different potential payouts (in virtual MegaBuck cash). In this embodiment and as shown in FIG. 7, the “VirtuaLotto” screen presents the player with the choice of purchasing a “BigLotto”, “MegaLotto” or “MonsterLotto” virtual lottery ticket, wherein the “BigLotto” ticket costs 20 Credits and can pay out 1 to 5 MegaBucks, the “MegaLotto” ticket costs 40 Credits and can pay out 2-15 MegaBucks, and the “MonsterLotto” ticket costs 60 Credits and can pay out 15-40 MegaBucks. When the player selects one of the virtual lottery tickets, the client application sends the player's selection to the server system 10 in a “Play Virtual Lottery” request.

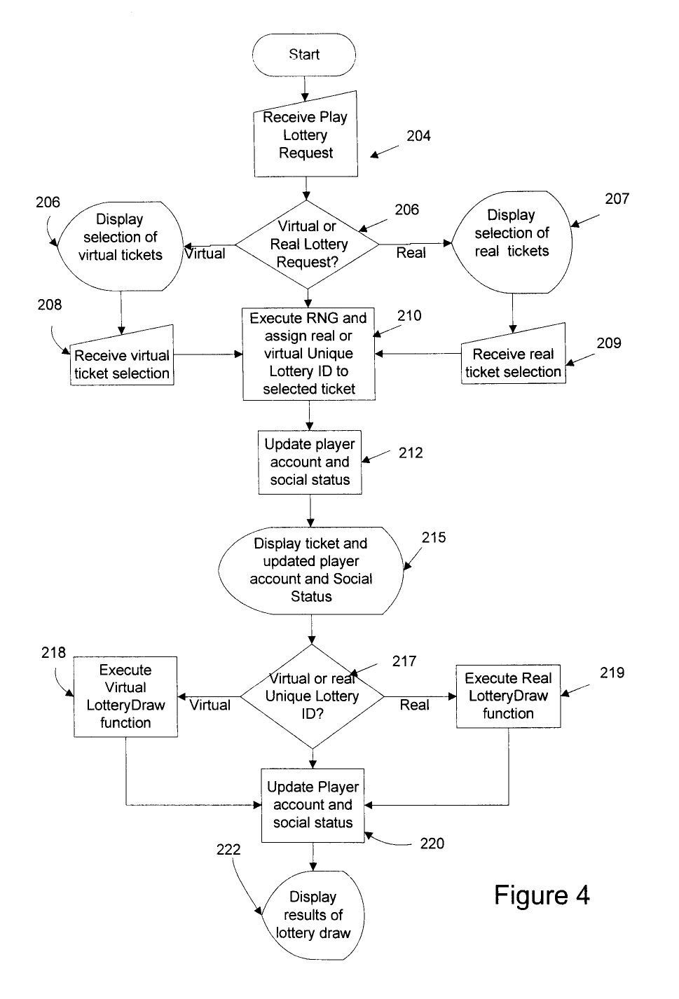

Upon receipt of the Play Virtual Lottery request by the program controller module 32, the proxy engine 40 forwards the request to the Lottery Services module 48. Referring now to FIG. 4, the lottery services module 48 upon receipt of the Play Virtual Lottery Request (step 204) executes a virtual lottery transaction subroutine (step 205). In this subroutine, the lottery services module 48 instructs the client application to display the appropriate screen on the client device, which in this case is the virtual lottery ticket screen as shown in FIG. 7 (step 206) with the option of choosing between three different virtual lottery tickets. When the player selects a virtual ticket from the available selection, the client application forwards this selection to the server system 10 (step 208). The lottery services module 48 then executes a random number generator (RNG) (step 210) to generate unique identifiers to the virtual ticket (“Virtual Unique Lottery ID”) which is then stored in the player's account in the database module 42 in the field “virtual lottery ticket information”. The player's credits balance in his account is then adjusted to reflect the credits used to purchase the virtual ticket (step 212). The lottery services module 42 then determines whether the player's social status has changed, where social status could refer to a player's winnings, prizes or goods acquired during the game, real or virtual gifts received from friends, position on a leaderboard, etc. and if yes, then the player's social status is updated (step 212). Then the lottery services module 42 for a virtual lottery transaction (step 217) executes a Virtual LotteryDraw function (step 218), wherein the Virtual Unique Lottery ID is read. In this embodiment, the size of the virtual winnings is determined from the randomly generated value of the Virtual Unique Lottery ID. In other words, if the Virtual Unique Lottery ID has a highest possible value, then the virtual winnings will be the highest possible winnings for the purchased ticket type, which is 5 MegaBucks for a bronze ticket, 15 MegaBucks for a silver ticket and 40 MegaBucks for a gold ticket. The player's virtual currency balance, and social status are then adjusted in the database module 42 in the manner as described above (step 220).

It should be noted that the outcome of the Virtual Lottery Draw function does not need to be communicated to the player immediately after the Virtual Unique Lottery ID is assigned, and can instead be scheduled to occur at some time in the future. In this embodiment, the player is notified immediately of the results of his lottery ticket draw (step 222), by the server system 10 transmitting the results of the lottery draw to the client computing device 12. These results include the value of the virtual lottery winnings and updated credit balance and virtual currency balance. When the client computing device 12 receives these results, the client application can optionally be programmed to display an animation congratulating the player on her virtual winnings. The virtual lottery transaction subroutine then ends and the game instance returns to the main menu 112 with the updated credit and virtual currency balances, as well as a change in the player's social status, if any.

Referring back to FIG. 3, the player with his new virtual winnings, can select “Buy Luxury Goods” (step 116), which executes a subroutine that enables the player to select virtual goods to purchase, e.g. a house. Once a virtual good is selected, the client application causes the client computing device 12 to send a “purchase virtual good” request to the server system 10 which includes a unique identifier associated with each purchased good. The server system 10 receives this request and causes the game engine module 35 to record the newly purchased item's unique identifier in the player's account on the database module 42 in the field “virtual goods inventory”, and to update the virtual currency balance in the account by subtracting the current balance with the virtual cost of the purchased goods.

Once a good is purchased, the client application presents the player with an opportunity to win a real version of this purchased virtual good (step 126) for a real cost. If the player selects this opportunity, the client application then causes the client computing device 10 to transmit a “Play Real Lottery” request to the server system 10 (step 128), which then causes the lottery services module 48 to execute the lottery subroutine again (step 124) but this time for a real lottery transaction. Referring again to FIG. 4, upon receipt of the Play Real Lottery Request (step 204), the lottery services module 48 executes a real lottery transaction subroutine (step 205). Since this time the player has requested to purchase a real lottery ticket and enter into a real lottery draw, the lottery services module 48 implements a real lottery transaction in the context of issuing a real lottery ticket. At step 207, the lottery services module displays a screen showing that a real lottery ticket to win the virtual good is about to be purchased, and then prompts the user to confirm the purchase (step 209). Once confirmed, the lottery services module 48 executes a random number generator (RNG) (step 210) to generate a Real Unique Lottery ID associated with the real lottery ticket.

Like the issuance of a virtual lottery ticket, the lottery services module 48 executes the RNG to generate unique identifiers, but this time the unique identifiers are associated with a real lottery ticket. The unique identifiers are stored in the player's account in the database module 42 under the field “real lottery ticket information” and the player's account Wallet and social status are updated to reflect the use of real funds to purchase of the real lottery ticket (step 212).

The lottery services module 48 then executes a Real Lottery Draw function wherein winning identifiers for a real lottery are compared against the Real Unique Lottery ID of each real lottery ticket (step 219). As the draw for the real prize can occur at a later time, the lottery services module 48 returns a “real lottery ticket purchased” response back to the client computing device 12 which then communicates a suitable message to the player (not shown in FIG. 4). The message can include the date of the draw, and advise the player that he will be automatically advised after the draw has been made whether he has a winning ticket. The draw can be performed manually, e.g. by a person drawing a number out of a container, in which case the winning numbers are manually inputted into the lottery server 26. Alternatively, the winning numbers can be drawn automatically by the lottery server 26 or by another computer server of the lottery authority. The lottery services module 48 compares the winning numbers against the real lottery ticket and if the lottery ticket is a winning ticket; the PAM module 44 updates the player's account Wallet (step 220) and social status. The server system 10 then sends a response to the client computing device 12 advising of the status of the lottery ticket (step 222). The real lottery transaction subroutine then ends and returns to the main menu (112).

Referring back to step 112 of FIG. 3, after a player has purchased a luxury good, he can take certain actions with respect to that good, by selecting the “Use Existing Item” option on the main menu (step 118). After this option has been selected, the client computing device 12 sends a “Use Purchased Items” request to the server system 10, which then causes the game engine module 35 to execute a Use Existing Items subroutine. The PAM module 44 checks the player account to determine what items have been purchased by the player, then causes the server system 10 to send a response to the client computing device 12 to cause the client application to display all the items that have been purchased and to prompt the player to select one of the items to use. Once the player has selected the item, a “Take Action” request is sent by the client computing device 12 to the server system 10 which causes the game engine to present all of the available actions for that particular items (step 130). These available actions can for example be stored on the database module 42, and for example, can include “hire a renovator” and “throw a party” actions for a house as the selected item.

Each action can be either a non-betting action (step 132) or a betting action (134). A non-betting action is simply a series of steps carried out to entertain the player, and can include fun animations and sounds, or interactive steps which allow the purchased item to be modified or used in some way. For example, when the action “hire a renovator” is selected, the game engine module 35 executes a series of steps which simulates the process of renovating a home, and can include for example, selecting paint colour, window coverings, flooring, and lighting. The steps can include animations which show the house after it has been updated with the player's choices. The non-betting action can simply end at this point, in which case the game engine module 35 causes the player account to be updated to store the modified properties of the purchased item, and to return the player back to the main menu. Alternatively, the non-betting action can include a challenging and fun task the completion of which by the player will be rewarded with a “present” that can contain a real world lottery ticket or a virtual prize or virtual currency (not shown); the contents of the present can be randomly determined by the RNG in the lottery services module 48. The real world lottery ticket is a ticket which the player had previously purchased as part of his game bundle or subscription play, and was heretofore hidden from the player and only unveiled upon successful completion of the task. Once the player opens the “present” and uncovers the hidden lottery ticket, the client computing device 12 sends a “play real lottery ticket” request to the server system when then causes the lottery services module 48 to execute the play real lottery transaction subroutine (steps 128 and 122) as previously described with reference to FIG. 4, to update the player account with the virtual present, currency or real lottery present (Step 111) then return to the main menu (step 112).

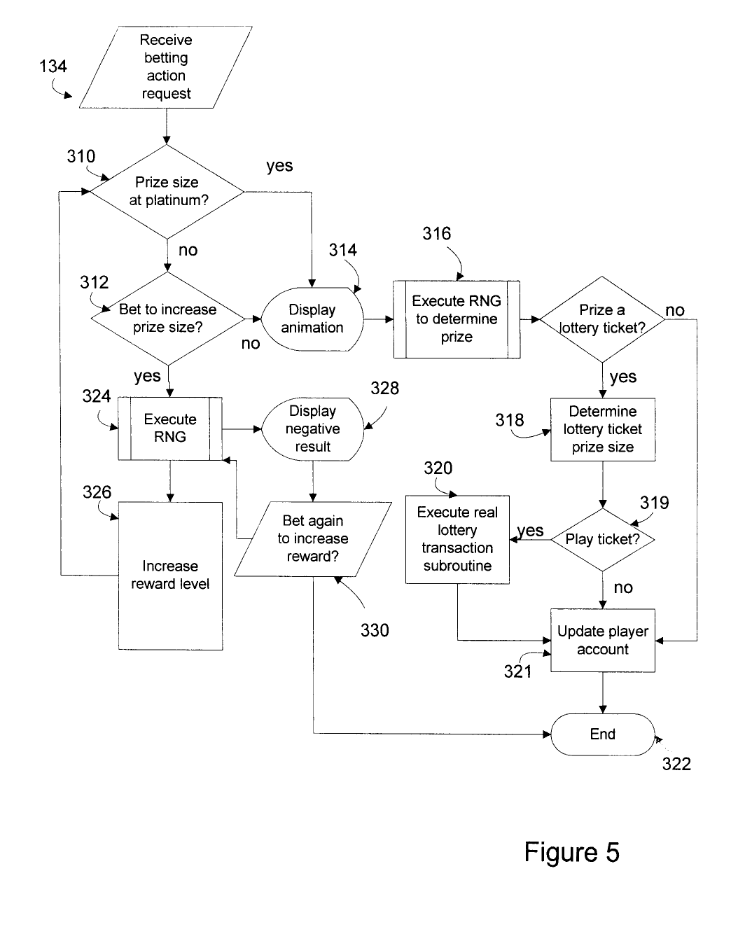

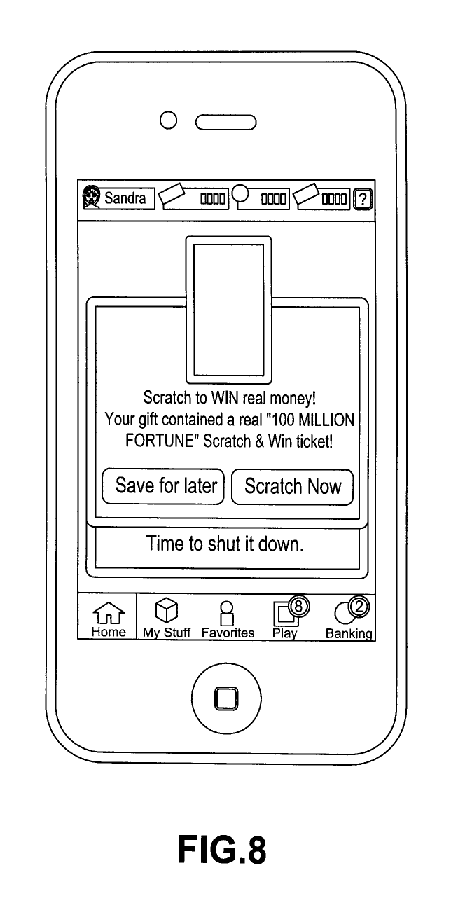

If instead the player selects another action that involves betting, the game engine executes the betting action subroutine (step 134). Referring now to FIG. 5, the betting action subroutine carries out a series of interactive steps that are fun and entertaining for the player which ultimately ends with the player winning a present that will contain a prize that can be a virtual item, virtual currency or a real lottery ticket (which can be previously purchased). The betting action subroutine also presents the player with a chance to increase the size of prize or to select the prize as presently achieved (labelled conveniently as “bronze”, “silver”, “gold” or “platinum”). When this subroutine is executed, the game engine module 35 checks the player account on the database module 42 whether the playing stakes have reached platinum (step 310)—initially the size of the prize is set at the lowest “bronze” value. If no, then the subroutine asks the players wishes to win a larger prize (step 312). If the player declines, then client application animates an opening present sequence (step 314). The lottery services module 48 executes the RNG to determine what type of prize is won (step 316); if the prize is a real lottery ticket, then the lottery services model selects the appropriate sized lottery ticket according to the size status of the prize (step 318). If the prize is not a real lottery ticket, the prize will be a virtual item or virtual currency and the player account is updated (step 321). The real lottery ticket is an instant-win type ticket and the client application presents the player with the option of play the ticket immediately, or save the ticket for playing at some later time (step 319, and see FIG. 8). If the player elects to play the ticket, the lottery services module 48 executes a real lottery transaction subroutine to generate winning identifiers and then to compare the winning identifiers with the unique identifiers of the issued real lottery ticket (step 320), in the same manner as previously described with reference to FIG. 4. Alternatively, these winning identifiers can be generated at another pre-defined period of time, e.g. when the instant-win tickets were purchased. (As previously discussed these lottery tickets were originally purchased by the player as part of the purchased game bundle, and the lottery services module 48 is executed to assign unique identifiers to the real lottery ticket). If the player's real lottery ticket is a winning ticket, the PAM module 44 updates the player account with the lottery winnings and that one of the lottery tickets has been used, and the client computing device 12 receives a message from the server system 10 to display a congratulatory message and to show the player's updated player account (step 321). If the lottery ticket is not a wining ticket, the player account is updated to reflect that one of the previously purchased lottery tickets has been used. The subroutine then ends and returns to the main menu (step 322).

If instead, the player accepts the chance to increase the size of the prize, the lottery services module 48 executes the RNG to determine whether the player has won or lost (step 324). If the player wins, the size of the prize increases by one increment (e.g. from bronze to silver) (Step 326). If the player loses, the size of the prize remains unchanged and the server system 10 sends a response to the client application to display a negative result (step 328), deducts credits from the player's credit balance in his account, and shows the player's latest account information. The game engine module 35 then causes the client application to offer the player another chance to increase the size of his prize by spending credits of real money (step 330); if the player accepts, then the lottery services 48 repeats the step 324 again. If the player declines, the subroutine ends and the game engine updates the player account and returns to the main menu.

### Security Protocols

Because the lotterized video game can execute real lottery transactions, security protocols are implemented in the lotterized video game that are comparable to known security protocols in place for conventional lottery transactions. Because the lotterized video game employs the same lottery subroutine to handle both virtual and real lottery transactions, both types of lottery gaming are subjected to the same security protocols.

Some examples of known lottery transaction security protocols that can be implemented in the lotterized video game include:
Encryption: All transport data between client device and server system is encrypted. For example, transaction calls can be secured at the transport level with the use of SSL 128 bit encryption (HTTPS); sensitive data can be encrypted using public and private key PGP, wherein keys are tied to the player to ensure that the player only has access to his/her data.
Audit Log: Any data that is entered or updated in the database module 42 causes an audit log to be generated.
Tracking: Tracking of Player's IP address, login times, number of failed logins, logging of large transactions,
Third party security verification: Use of third party validator and auditing services, e.g. to verify Player's credit card and credit history.
Access Controls: For application level, and authentication using password requirements and geolocation.
Backend Security for Databases: Game data is protected by applying hardening standards to servers and databases, and logging of all queries and information that is transferred and accessed.
Integration with Event Log Management Systems: (a) O/S level logs, (b) Application level logs, (c) database logs, (d) error and activity logs.
Integration with Intrusion Detection Systems

Some or all of the above security protocols can be implemented to prevent any alteration of play selection, results of a game play instance, or RNG results. Auditing and logging components are in place in the lottery subroutine (see FIG. 4) to detect and recover from any unauthorized changes in data. All activities (sales and non-sales) are recorded, and any discrepancies are alerted and reported.

While exemplary embodiments of the invention have been illustrated and described, it will be appreciated that various changes can be made therein without departing from the scope and spirit of the invention.

### EXAMPLE

The following is an example of the execution of the betting action subroutine in relation to the purchase of a virtual mansion, wherein the betting action involves throwing a party:

A player is presented with a screen displaying available actions related to her virtual mansion. Each action gives the player a chance at winning a present, which will contain some virtual prizes, and a chance at a real-money scratch ticket. Her selectable choices (underlined) are:
(a) You own a mansion! Throw a party!
(b) Those drapes are so 2009. Hire a designer to remodel.

The player chooses “Throw a party”.

Next, the player presented with a screen informing her that she has 10 invitations banked, and is asked if she would like to use them to invite some friends. An explanation is provided that the invitations are special gifts that invite her friends to play the game with her, but also are tickets that can win her friends real money, if they have a player account.

Every recipient of an invitation, regardless of whether or not they are a currently active player, receives some kind of benefit for the interaction. For example:
A real “scratch and win” real lottery ticket that could pay real money
A virtual gift related to the theme of the interaction
Virtual MegaBuck currency

Next, the party is “scheduled”. Some humorous text is presented with a funny animation, and a countdown timer starts to count down to the start of the party. When the timer has finished counting down, the player is presented with screen having a series of choices to make related to the party. She is informed that she has a “bronze-level” Present, and that she has a chance to increase the value of her Present. Each choice lets her keep the Present she has currently possesses, or take a risk with a chance of winning the next level of Present. In this example, the player is presented with the following sequence of choices:
“The party is going great, and the house is pretty full. Lots of people keep showing up at the door though. Do you want to:
(a) Cut off the guest list. This party is full enough! (accept the Bronze-level present)
(b) The more the merrier! . . . or maybe things will get out of hand. (take a chance on winning a silver-level present)”

Choosing (b), the player runs the risk that the party will get too crowded and collapse, and she will lose her present. The result is randomly determined. If she fails here, she can “buy back in” by spending some additional real currency from her wallet on a “power-up” to undo the negative effects of her choice.

The player is then presented with some party animation, or the game may allow so time to pass by while the party continues in the background. After an amount of time passes, the user is notified that another action is required such as a screen with a second “double down” betting action:
“The party's going great with all the extra people, but the tunes on the MP3 Player are a bit dull. Do you want to hire a DJ?”
(a) I don't think so. The party's wild enough. (keep the silver present)
(b) Oh Yeah! A DJ will give the dance floor a boost . . . hope the neighbours don't mind. (take a chance on winning a gold-level present)

The player chooses (b). The result is randomly determined. After being presented with some more party animation, the player is presented with a screen displaying a third “double down” choice:
“The neighbours are freaking out. The party can be heard for miles. What do you want to do?
(a) Time to shut it down. (keep the gold)
(b) Invite them all in! Open another case of champagne! . . . hope the cops don't show up. (take a chance on winning a diamond-level present)”

The player chooses (b). The result is randomly determined. If the party did not go bust she is presented with a screen awarding her a Present and displaying a caption over the present: “Congratulations! Your party rocked so much that your guests sent you a present!” She is presented with an option to open the Present.

She selects “open the Present” and is awarded a prize. The prize can be a virtual good, a virtual currency or one of the hidden real lottery tickets.

The player continues the process of allocating her virtual money winnings, and engaging in activities until she's used up her available virtual currency.

After a programmed period of time, the game application will generate some additional content for her:
A fake news story with the player's name and so on is generated from a fake “gossip rag” talking about her party. She gets a Present from the editor of the magazine thanking her for such a great story. Then the player is presented with a button that says:
“The story of your party is all over the gossip mags. Would you like to tweet the news story, or post it to your Facebook wall?”
Would you like to forward this directly to your friends?

The player selects: “Yes” and then selects some friends from her contact list. The game application sends these friends a link to the fake news story via email.

Other examples of content that can be generated:
One of the guests at the party left behind a magic lamp/monkey paw that when rubbed, gives the player a Present
A set of car keys was left behind (which can represent a real lottery ticket for a draw for a real car)

This is the final stage of the activity and the game play is complete. The player may start the whole process again by spending more Credits, or buying more Credits to spend them, or waiting until their subscription delivers them more Credits on a schedule.

What is claimed is:

1. A system for executing a lotterized video game, comprising:
at least one computer server communicable with at least one client computing device over a network, the server having a processor and a memory with program modules stored thereon and executable by the processor, the program modules comprising:
a game engine module having program code that when executed, generates an interactive game play instance playable on the client computing device; and
a lottery services module having program code that when executed, conducts a real lottery transaction within the game play instance.

2. A system as claimed in claim 1 wherein the game engine module further comprises program code that when executed, generates an interactive game play instance which provides a player with play options including purchasing a virtual good, and requesting a real lottery transaction associated with the virtual good which when selected executes the lottery services module program code to conduct the real lottery transaction.

3. A system as claimed in claim 2 wherein the lottery services module further comprises program code that when executed, issues a unique identifier associated with a real lottery ticket, and compares the issued unique identifier with a winning identifier in a real lottery draw.

4. A system as claimed in claim 3 wherein the program modules further comprise a player account management module having program code that when executed, determines whether a player of the game play instance is eligible to conduct the real lottery transaction, by receiving player information from the client computing device comprising at least one of player age, residence and location, and comparing the received player information to player eligibility information stored on the server.

5. A system as claimed in claim 4 wherein the program modules further comprise a database module having a database storing player account information including the player information, the issued unique identifier associated with a real lottery ticket, and an inventory of purchased virtual goods.

6. A system as claimed in claim 2 wherein the game engine module further comprises program code that when executed, presents to the player an opportunity to purchase a real lottery ticket to win a real version of the virtual good, and wherein the lottery services module further comprises program code that when executed issues one or more unique identifiers associated with the real lottery ticket, and compares the issued unique identifiers with winning identifiers in a real lottery draw for the real version of the virtual good.

7. A system as claimed in claim 1 wherein the game engine module further comprises program code that when executed, provides a player with game play purchase options including purchasing a real lottery ticket which when selected executes the lottery services module program code to conduct the real lottery transaction.

8. A system as claimed in claim 7 wherein the lottery services module further comprises program code that when executed, issues a unique identifier for at least one real lottery ticket in response to the purchase of the real lottery ticket, and the game engine module further comprises program code that when executed, presents a task element during the game play instance and displays the at least one real lottery ticket on the client computing device when the task element is successfully completed by the player.

9. A system as claimed in claim 1 wherein the lottery engine module further comprises program code that when executed, generates a virtual lottery ticket by receiving a virtual lottery ticket transaction request from the client computing device during the game play instance, processing the transaction request, and randomly generating a virtual prize in response to the virtual lottery ticket transaction request.

10. A method for executing program code for a lotterized video game on at least one computer server communicable with at least one client computing device over a network, comprising:
executing program code of a game engine module which generates an interactive game play instance playable on the client computing device; and
executing program code of a lottery services module which conducts a real lottery transaction within the game play instance.

11. A method as claimed in claim 10 wherein executing the program code of the game engine module further comprises generating an interactive game play instance which provides a player with play options including purchasing a virtual good, and requesting a real lottery transaction associated with the virtual good which when selected executes the lottery services module program code to conduct the real lottery transaction.

12. A method as claimed in claim 11 wherein executing the program code of the lottery services module further comprises issuing a unique identifier associated with a real lottery ticket and comparing the issued unique identifier with a winning identifier in a real lottery draw.

13. A method as claimed in claim 12 further comprising executing program code of a player account management module which determines whether a player of the game play instance is eligible to conduct the real lottery transaction, by receiving player information from the client computing device comprising at least one of player age, residence and location, and comparing the received player information to player eligibility information stored on the server.

14. A method as claimed in claim 13 further comprising executing program code of the player account management module which stores player account information including the player information, the issued unique identifier associated with a real lottery ticket, and an inventory of purchased virtual goods on a database.

15. A method as claimed in claim 14 further comprising executing program code of the game engine module which presents to the player an opportunity to purchase a real lottery ticket to win a real version of the virtual good, and wherein the lottery services module further comprises program code that when executed issues one or more unique identifiers associated with the real lottery ticket, and compares the issued unique identifiers with winning identifiers in a real lottery draw for the real version of the virtual good.

16. A method as claimed in claim 10 further comprising executing program code of the game engine module which provides a player with game play purchase options including purchasing a real lottery ticket which when selected executes the lottery services module program code to conduct the real lottery transaction.

17. A method as claimed in claim 16 further comprising executing program code of the lottery services module which issues a unique identifier for at least one real lottery ticket in response to the purchase of the real lottery ticket, and executing program code of the game engine module which presents a task element during the game play instance and displays the at least one real lottery ticket on the client computing device when the task element is successfully completed by the player.

18. A method as claimed in claim 10 further comprising executing program code of the lottery engine module which generates a virtual lottery ticket by receiving a virtual lottery ticket transaction request from the client computing device during the game play instance, processing the transaction request, and randomly generating a virtual prize in response to the virtual lottery ticket transaction request.

19. A computer readable medium having encoded thereon
program code of a game engine module executable by a processor to generate an interactive game play instance playable on a client computing device; and
program code of a lottery services module executable by a processor to conduct a real lottery transaction within the game play instance.
